(19) United States
(12) Patent Application Publication
(10) Pub. No.: US 2013/0088710 A1
(43) Pub. Date: Apr. 11, 2013

(54) Optical Guide-Based Displacement/Force Sensor

(71) Applicant: Francois Jean Michel Bergeron, Montreal (CA)

(72) Inventors: Tiberius Eugen Brastaviceanu, Montreal (CA); Ivan Alexandrovich Pavlov, Montreal (CA)

(73) Assignee: Francois Jean Michel Bergeron, Montreal (CA)

(21) Appl. No.: 13/646,707

(22) Filed: Oct. 7, 2012

Related U.S. Application Data
(60) Provisional application No. 61/545,054, filed on Oct. 7, 2011.

(51) Int. Cl. G01B 11/14

(52) U.S. Cl. CPC G01B 11/14
USPC 356/72

(57) ABSTRACT

A displacement and force sensor device using as a transducer an opto-mechanical assembly including an optical guide is claimed here. The transducer operates in bending mode, where the amount of bending induces a change in light signal intensity propagating through the transducer. The change in light signal is proportional to the bending and proportional to the force applied on the transducer after calibration of the said transducer. The transducer is free-ended and needs at least one point of contact with the test specimen to induce bending or with the material in contact with the test specimen. The sensor can give information about displacement and force. Said specimen can be solid, liquid or gas. The transducer can be incorporated into a material which stiffness is measured. The transducer is capable of sensing displacement in the sub-pm scale, with sub-ms time resolution, and to measure forces as small as 10⁻⁶ N.

### CROSS-REFERENCE TO RELATED APPLICATION

Related Prior Publication Data: provisional application No. 61/545,054, filed on Oct. 7, 2011.

### FIELD OF THE INVENTION

The present invention relates to measuring instruments. More particularly, the invention relates to an instrument for measuring displacement and force using an optical guide-based transducer, based on loss of light transmission phenomenon. This invention uses optical guide technology for a very sensitive, contact, unidirectional, displacement and force sensor, to be applied in probing dynamic mechanical effects at sub-μm scale, with sub-millisecond time resolution, produced by forces that can be smaller than one micro Newton. By unidirectional we mean that the transducer is able to detect a force, or a resultant of forces oriented along one direction at a time. Forces in all directions perpendicular to the long axis of the transducer can be detected. If more than one force is acting on the transducer at once only their resultant perpendicular to the long axis of the transducer can be detected. If no other information about these forces is given the sensor itself cannot uncouple them.

### BACKGROUND OF THE INVENTION

In the past few years optical guide-based displacement/force transducers and pressure transducers have gained acceptance in the market as an alternative to conventional electronic transducers which are based on changes in electrical resistance, inductance, capacitance, piezoelectricity, and probably others.

Optical guide-based displacement/force transducers and pressure transducers offer several advantages over conventional transducers. Unlike electronic transducers, optical guide-based transducers are not sensitive to electromagnetic interference and are well suited for use in electrically-noisy environments. Optical guide-based transducers can be made very small and lightweight for use in confined spaces. They can be made to withstand high temperature and corrosive environments, or to be biologically friendly.

A wide variety of optical guide-based transducers that utilize various optical properties to measure a physical property of interest are available. They are designed to respond to the physical property to be measured by a change in amplitude, phase, polarization state, or other optical properties of light transmitted through the optical guide. Per example, U.S. Pat. No. 4,701,614 describes the loss light properties of concentric coating layers in an optical fiber in order to measure bending and pressure. U.S. 2008/0159687 reports the application of a Fabry-Perot optical fiber sensor to sense pressure. U.S. Pat. No. 6,417,507 depicts optical fiber Bragg grating for absolute gauging of strain. Depending on the optical guide-based transducer's design, one or more of these optical properties can be monitored by an interrogation unit and converted into the physical property of interest.

Although the industry has various solutions to measure forces and displacements, the used detectors do not combine enough the following qualities: accuracy, speed and reliability of the measurements, especially in the forces under the microN range and the displacements of microns, good signal/noise ratio, low cost sensors and low-cost electronic analyzers, temperature and external conditions independance, small footprint for sensors and analyzers, per example.

There is accordingly a demand for sensing solutions presenting the maximum number of the advantages cited above, especially in the fields of robotics and automation, structure monitoring, scientific measurement and medicine. This invention relates to an optical guide assembly suitable particularly, but not exclusively, for the characterization of mechanical properties of different biological cellular and sub-cellular structures, in vivo or in vitro. Among alternative targeted applications are 1) fatigue tests monitoring for structures (per example aircraft parts), 2) smart gripping devices, 3) flow sensors or pressure sensors for gases and liquids, 4) vibration sensors, 5) tactile sensors for surgery, and so on.

### BRIEF SUMMARY OF THE INVENTION

The current invention relates to optical guide-based transducers designed to measure displacement and/or force by monitoring their deformation (bending) caused by an external force, and to deduce this external force from the information collected on the deformation and from the mechanical properties of the transducer.

The optical guide-based transducers of this invention are designed to be installed and used in a manner similar to non-optical transducers, but to have the advantages of an all-optical transducer. The optical guide-based transducers of this invention are also designed to be used where optical transducers are applied, but with the advantage of an increased sensitivity to forces in the range of nN to mN, the advantage of sensitivity to measure adequately displacements in the range of micrometers to centimeters, the advantage of the cost of the electronics needed to generate and analyze the light used in the device and the advantage of lowered sensitivity to ambient conditions (pressure, temperature, etc.).

Optical guide-based transducers of this invention are of the type one point of contact, i.e. they must be in physical contact with a specimen at least in one point.

The present invention relates to an optical guide transducer consisting in part of a flexible joint, which constitutes a variable gap between an optical guide and a mirror. The light propagating through the optical guide—part of the transducer exits it, bounces off the mirror, and a part of it reenters the optical guide. The amount of light reentering the optical guide depends on the distance between the mirror and the exit surface of the optical guide, and on their relative orientation (angle or distance). A very small movement of the mirror can translate into a measurable variation in intensity of the light reaching the detector. Thus the transducer is composed of the optical guide, the compliant joint, and the lever that carries the mirror.

### BRIEF DESCRIPTION OF THE DRAWINGS

FIG. 1 is a schematic representative view of a preferred embodiment of the invention.

FIG. 2 depicts the transducer, part of the displacement/force sensor-device described in this document.

### DETAILED DESCRIPTION OF AN EXAMPLE EMBODIMENT OF THE INVENTION

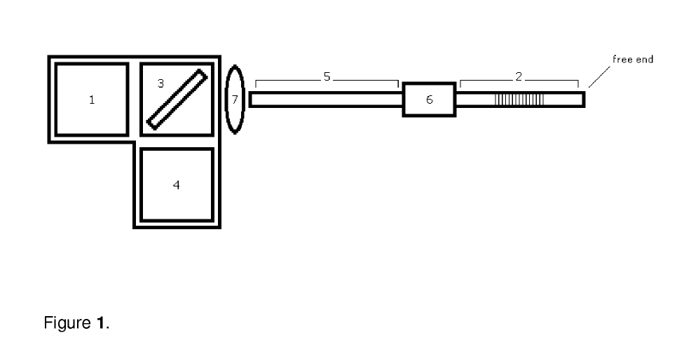

A schematic representative view of the preferred embodiment of the invention is depicted in FIG. 1. The source 1 can be any light source, and is preferably a laser source emitting laser light at any possible wavelength. In one possible embodiment the source is a multimode laser emitting at 1.3 or 1.5 μm wavelength. Light is the carrier of information about the bending state of the transducer 2, and hence about the force acting on it through at least one point of contact with the specimen.

The beam splitter 3 is an optical device that lets the light emitted by the source 1 to pass through it almost unaffected, towards the transducer 2. The beam splitter 3 also deflects the light propagating back from the transducer 2, towards the detector 4, minimizing the amount of light going back to the source 1. The beam splitter is optional. In the case where no beam splitter 3 is used, this part may be replaced by an optical circulator, or by an optical Y junction and so on. In a possible embodiment an optical insulator may also be used to decrease the quantity of light reaching the source 1.

The detector 4 is a photo-detector, preferably consisting of a fast photodiode used to measure the intensity of the light coming back from the transducer 2, deflected by the beam splitter 3. The delivery guide 5 is an optical guide corresponding to the source 1, used to transport the light signal emitted by the source 1 to the transducer 4, passing through the connector 6, and back to the detector 4. In one possible embodiment the delivery guide 5 is a 62 microns core multimode glass fiber.

The lens 7 is an optional optical device used to couple the emission from the source 1 into the delivery guide 5 and to re-collimate the light propagating in the opposite direction, coming from the transducer 2 towards the beam splitter 3. The connector 6 is an optional opto-mechanical assembly used to couple the light signal propagating through the delivery guide 5 into the transducer 2 and vice versa. It allows these two components to be physically separated or put together at will and with ease. The delivery guide 5 and the optical guide of the transducer 2 are not necessarily the same, and may even have different physical dimensions. Some percentage of light may be lost between the two optical guides, but this is not a problem if this loss is stable, i.e. not very sensitive to mechanical noise around the connector 6. The connector 6 also makes it easy to disconnect (i.e. to physically separate) and to reconnect (i.e. to put together) the transducer 2 from the delivery guide 5.

Free end illustrates the fact that the transducer has one end free to physically move in space if it is pushed by a force.

The transducer 2 is the part of the device responsible for sensing. It is responsible for converting one physical quantity into another one. In our case, the physical deformation (bending) of the flexible joint 8 of the transducer 4 is translated into an intensity modulation of the laser light signal passing in both directions through the flexible joint 8. In one possible embodiment the transducer 4 has a cylindrical shape, but it is not limited to this.

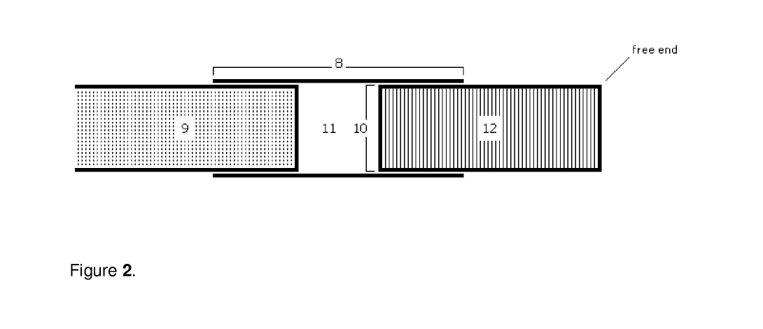

The schematic description of the transducer 4 is also shown in more detail in FIG. 2. The transducer 4 is the sensing part of the force/displacement sensor described here.

The flexible joint 8 is a part of the transducer 4 that transfers deformation (bending) into intensity modulation. The flexible joint 8 part consists of a flexible material between an optical guide 9 and a mirror 10 (FIG. 2). The flexible joint 8 can be of any compliant material. The elastic properties of the flexible joint 8 determine the range of forces that can be measured and the temporal resolution of the sensor. In one possible realization in which the transducer 4 is of cylindrical shape, the flexible joint 8 can be a cylindrical tube.

The optical guide 9 allows the laser light emitted by the source 1 (see FIG. 1) to propagate through the gap 11 to the mirror 10 and back to the detector 4. In one possible embodiment the optical guide 9 is a cylindrical optical fiber. The gap 11 is a separation between the optical guide 9 and the lever 12 of a certain distance, filled with a dielectric material, which can even be air. The gap 11 can be compressed or deformed off axis (bending).

The lever 12 is a stiff and inert component of the transducer 4. It can be of any length and/or shape, used to make contact with the measured object. The lever 12 is attached to the flexible joint 8. The mirror 10 is attached to the lever 12. The lever 12 can be of any stiff material and it carries a mirror 10 on its end closer to the optical guide 9 (see FIG. 2).

The mirror 10 reflects the light coming out of the optical guide 9 back into the optical guide 9. It can also be a partial mirror (not reflecting 100% of light back). The mirror 10 can be directly coated on the tip of the lever 12 (as depicted in FIG. 2), or it can be mechanically attached to it, or it can be created on the lever 12 by polishing it.

The flexible joint 8 is an elastic material that holds tight the lever 12 and the optical guide 9 together. The flexible joint 8 allows the mirror 10 on the lever 12 to move with respect to the exit surface of the optical guide 9. This movement is responsible for sensing: as the mirror's orientation changes, the coupling with the optical guide changes, and as a result of it the intensity of the light reaching the detector 4 also changes. In one possible embodiment in which the optical guide 9 is a cylindrical optical fiber and the lever 12 is also a cylindrical object, the flexible joint 8 is a flexible tube. The flexible joint 8 provides a point of deformation.

### Functioning Principle

The source 1, is used to send a light signal through an optical guide 9, herein called the delivery guide 5, which is connected with the connector 6 to the transducer 2 (FIG. 1). After the connector 6, the light goes through the transducer 2, through the flexible joint 8 and is reflected back from a mirror (see FIG. 2) towards the source 1 through the same delivery guide 5, going through the flexible joint 8 for a second time. Before reaching the source 1, the light signal can be deflected by the beam splitter 3 towards the detector 4. The beam splitter 3 is optional. In the case where no beam splitter 3 is used, this part can be replaced by an optical circulator, or by an optical Y junction and so on.

The flexible joint 8 is the part of the transducer 4 responsible for the sensitivity of the sensor. The flexible joint 8 constitutes a variable gap between an optical guide and a mirror 9 (FIG. 2). The transducer 4 is free-ended and compliant. The force and/or displacement applied perpendicular to the long axis causes deformation of the flexible joint 8 and can be detected. Deformation affects the structure of the flexible joint 8, which in turn changes the way light propagates through it, affecting the intensity of the light signal going back on the delivery guide 5, which is measured by the detector 4. The deformation (bending) of the flexible joint 8 of the transducer 4 is thus correlated to the intensity variation of the light signal sent back to the detector 4.

The stiffness of the transducer 4 is precisely measured, and it is used to convert its deformation under a force to absolute force. Information about the deformation of the flexible joint 8 of the transducer 4 is carried by the intensity of laser light that propagates through it. A calibration procedure is needed to correlate deformation to intensity loss.

In other words, the light exits the optical guide 9—part of the transducer 4, bounces off the mirror 10, and a part of it reenters the optical guide 9. The amount of light reentering the optical guide 9 depends on the distance between the mirror 10 and the exit surface of the optical guide 9, and on their relative orientation (angle or distance). A very small movement of the mirror 10 can translate into a measurable variation in intensity of the light reaching the detector 4. Thus the transducer 4 is composed of the optical guide, the compliant joint 7, and the lever 12 that carries the mirror 10.

The width of the gap 10 can be of any practical length, as long as some light reenters the optical guide 9 to be transported back to the detector 4, and as long as there is some room for enough deformation of the flexible joint 8. The width of the gap 11 can be optimized, taking into consideration other parameters.

The flexible joint 8 can be of any material, as long as some important criteria are met. The flexible joint 8 is an integral part of the transducer 4 and its mechanical properties must be carefully chosen. Its compliance is related to the force sensitivity. Its frequency of resonance is related to the temporal resolution of the sensor. The joint plays an important structural role, if it is too compliant the transducer 4 cannot hold in one piece.

The invention claimed is:

1. a transducer sensitive to deformation using an opto-mechanical assembly that includes an optical guide, operating in bending mode, where the amount of bending induces a change in the intensity of the light signal propagating through the transducer, with at least one point of contact needed with the test specimen to induce bending, and the sensor giving information on displacement and force, said specimen being solid, liquid or gas.

2. a displacement and force sensor device using a transducer according to claim 1 and comprising also of a light source, a light detector and a device or a material (light guide) aimed to physically connect the three following parts: light source, light detector, transducer.

3. a displacement and force transducer according to claim 1, embedded in a material which deformation is to be measured,

4. an arrangement of several displacement and force transducers according to claim 1, embedded or not in a material which deformation is to be measured,

5. a displacement and force sensor device according to claim 2, with a transducer embedded or not in a material which deformation is to be measured, without the use of a beam-splitter but using a Y-junction or a circulator or any other device able to distribute light,

6. a displacement and force transducer according to claim 1, embedded or not in a material which deformation is to be measured, without the use of a connector,

7. a displacement and force transducer according to claim 1, embedded or not in a material which deformation is to be measured, without the use of a lens,

8. a transducer sensitive to deformation according to claim 1, having a pre-bent shape, that is, a bent optical guide and a bent lever, these two being bent before the measurement, or a bent optical guide with a non-bent lever, or a non-bent optical guide with a bent lever, and this pre-bent transducer can allow measuring force and displacement applied axially on the transducer.
